(19) United States
(12) Patent Application Publication
(10) Pub. No.: US 2016/0063894 A1
(43) Pub. Date: Mar. 3, 2016

(54) ELECTRONIC APPARATUS HAVING A VOICE GUIDANCE FUNCTION, A SYSTEM HAVING THE SAME, AND A CORRESPONDING VOICE GUIDANCE METHOD

(71) Applicant: SAMSUNG ELECTRONICS CO., LTD., Suwon-si (KR)

(72) Inventor: Yui-yoon LEE, Busan (KR)

(73) Assignee: SAMSUNG ELECTRONICS CO., LTD., Suwon-si (KR)

(21) Appl. No.: 14/841,847

(22) Filed: Sep. 1, 2015

(30) Foreign Application Priority Data
Sep. 1, 2014 (KR) 10-2014-0115323

(51) Int. Cl. G09B 21/00; G06F 3/0484; G06F 3/16; G10L 13/02

(52) U.S. Cl. CPC G09B 21/006; G10L 13/02; G06F 3/04842; G06F 3/165

(57) ABSTRACT

An electronic apparatus having a voice guidance function includes: a text to speech (TTS) engine configured to convert a text included in a function of the electronic apparatus into a voice signal; a user identifier configured to acquire user information; an audio processor configured to output an audio signal corresponding to content received by the electronic apparatus and a mixed sound signal including the audio signal and the voice signal; and a controller configured to control the audio processor to selectively output at least one of the audio signal and the mixed sound signal in accordance with the user information acquired by the user identifier.

### CROSS-REFERENCE TO RELATED APPLICATIONS

This application claims priority from Korean Patent Application No. 10-2014-0115323, filed on Sep. 1, 2014 in the Korean Intellectual Property Office, the disclosure of which is incorporated herein by reference in its entirety.

### BACKGROUND

1. Field

Apparatuses and methods consistent with the exemplary embodiments relate to an electronic apparatus having a voice guidance function, a system having the same, and a corresponding voice guidance method. For example, the exemplary embodiments include an electronic apparatus having a voice guidance function for a person having a disability that is also convenient for a person not having a disability who watches or listens to audio media, television or other multimedia content together with the person having a disability.

2. Description of the Related Art

With the development of the electronic industry, electronic apparatuses, for example digital televisions (TVs), display apparatuses, and the like, have been transformed into “smart” devices having features, such as cameras, Internet communication, and information retrieval, in addition to their standard features.

As awareness of the problems faced by persons having disabilities has continued to improve, there has been an increased need for display apparatuses having a voice control function for persons with a visual impairment.

Accordingly, when a function of a display apparatus is used that requires vision enablement, an aural or phonic guidance function may be used to output an audible voice as a guide to various display and selection states of the corresponding function so that a person having a visual impairment can easily use the corresponding function.

However, a conventional display apparatus having an aural or phonic voice guidance function for persons having a visual impairment provides the voice guidance function together with the sound of the multimedia content received by the electronic apparatus, such as the sound of a broadcasting program or a video on demand (VOD) service, etc., through an output portion, e.g., a loud speaker. Therefore, if a person not having a visual impairment watches the display apparatus together with a person having a visual impairment, the person not having a visual impairment cannot avoid hearing the voice of the voice guidance function guiding the person having a visual impairment through the display and selection states regarding the function of the display apparatus while attempting to listen to the sound of the content. As a result, the sound of the voice guidance function guiding the person having a visual impairment through the display and selection states of the corresponding function disturbs the person not having a visual impairment who is listening to the sound of the content, and therefore the person not having a visual impairment cannot fully enjoy listening to and watching the content.

### SUMMARY

An aspect of an exemplary embodiment provides an electronic apparatus having a voice guidance function that can selectively output a received audio signal and/or a mixed sound signal comprising the received audio signal and a voice signal for guiding a user through a function of the electronic apparatus, in accordance with whether a user has a visual impairment. Thus, the electronic apparatus is convenient not only to the person having the visual impairment, but also to a person not having a visual impairment who watches or listens to multimedia content together with the person having a visual impairment.

In accordance with an exemplary embodiment, there is provided an electronic apparatus having a voice guidance function, the electronic apparatus including: a text to speech (TTS) engine configured to convert text included an element of a Graphical User Interface (GUI) of the electronic apparatus into a voice signal; a user identifier configured to acquire user information of users of the electronic apparatus; an audio processor configured to output an audio signal corresponding to content reproduced by the electronic apparatus and a mixed sound signal comprising the audio signal and the voice signal; and a controller configured to control the audio processor to selectively output at least one of the audio signal and the mixed sound signal in accordance with the user information acquired by the user identifier.

The electronic apparatus outputs the audio signal and the mixed signal, thereby allowing a user to selectively access the audio signal or the mixed sound signal as necessary. For example, if a user is a person not having a visual impairment, the user may have access to only the audio signal. If a user is a person having a visual impairment, the user may have access to the mixed sound signal. As a result, the person not having a visual impairment can more fully enjoy the multimedia content than a user of the conventional apparatus in which the person not having a visual impairment cannot avoid listening to the mixed sound signal together with the person having a visual impairment.

The element may include a graphic user interface (GUI) text. The element may include one of a channel change function, a volume control function, a selection function for an electronic program guide (EPG), a selection function of a menu item, and a selection function for an index added with an address of a web page, which are displayed together with a display of a text, such as a word, a letter, a numeral, a character, and combinations thereof before and/or after performing the function. Thus, a person having a visual impairment can be guided by a voice with regard to the various functions using the GUI or text in the electronic apparatus.

The user identifier may include: a characteristic recognizer configured receive information from a user, including information regarding a user's unique characteristics; and a user analyzer configured to analyze whether a user is a person having a visual impairment based on the information received by the characteristic recognizer and to generate a user information signal corresponding to a result of the determining. Thus, the electronic apparatus may automatically acquire the user information regarding whether a user is a person having a visual impairment.

The information received from the user may include one of face information, iris information, voice print information, and finger print information.

The electronic apparatus may further include a user input portion configured to receive a first and second input from a user. The user input portion may include a remote controller or a touch screen to receive the first input. The controller may selectively control the audio processor to output only the audio signal, and/or may control the audio processor to output only the mixed audio signal, in accordance with at least one of the first input received through the user input portion and the user information acquired by the user identifier. The first input may include a selection from among a voice guidance mode and a general mode. The second input may include a selection from among at least one of a channel, a volume, an EPG, a menu item, and an index added with an address of a web page, wherein the general mode is a mode without voice guidance.

Therefore, even if the user identifier is not operating, a user, e.g., a person having a visual impairment, can engage the voice guidance mode through the user input portion and thus may receive voice guidance through the function of the electronic apparatus. Further, if the user identifier is unable to quickly determine whether the user desires the voice guidance mode or the general mode, the user can quickly change the electronic apparatus to the desired function.

The electronic apparatus may further include an audio output portion configured to receive the audio signal and the mixed sound signal from the audio processor, to output a sound corresponding to the audio signal, and/or to provide a hub for selectively transmitting the audio signal and the mixed sound signal. The audio output portion may include: a first output portion configured to output the sound corresponding to the audio signal; and a second output portion configured to provide the hub for selectively transmitting the audio signal and the mixed sound signal. Thus, a user can selectively have an access to the audio signal or the mixed sound signal as necessary.

The first output portion may include a speaker, and the second output portion may include a jack configured to connect with a connection terminal of a first sound output device, and a wireless transmitter configured to wirelessly communicate with a wireless receiver of a second sound output device. The first sound output device may include one of an earphone and a headphone, and the second sound output device may include one of a wireless earphone, a wireless headphone, and a hearing aid. Thus, a user can have an access to the audio signal or the mixed sound signal through various methods.

The electronic apparatus may further include a display configured to display an image corresponding to the content reproduced by the electronic apparatus. Thus, the electronic apparatus may be applied to a digital TV, a smart TV, an Internet protocol (IP) TV, and the like.

In accordance with additional aspects of an exemplary embodiment, there is provided a voice guidance system including: the foregoing electronic apparatus having a voice guidance function; and a display apparatus configured to display an image corresponding to content reproduced by the electronic apparatus.

In accordance with additional aspects of an exemplary embodiment, there is provided a voice guidance method for an electronic apparatus, the method including: acquiring user information of users of the electronic apparatus; and selectively outputting at least one of an audio signal, corresponding to content reproduced by the electronic apparatus, and a mixed sound signal, including the audio signal and a voice signal converted from text included in an element of a Graphical User Interface (GUI) of the electronic apparatus, in accordance with the acquired user information.

Thus, the electronic apparatus may output the audio signal and the mixed signal individually, thereby allowing a user to selectively access the audio signal or the mixed sound signal as necessary.

The acquiring may include: receiving information from a user of the electronic apparatus; and acquiring the user information based on the information received from the user. The user information may include information indicating whether the user has a visual impairment, and the information received from the user may include one of face information, iris information, voice print information, and finger print information.

Additional aspects of an exemplary embodiment may further include the steps of: determining whether a user having a visual impairment is present based on the user information; and, if the user having a visual impairment is not present, outputting only the audio signal; and, if the user having a visual impairment is present, outputting the mixed sound signal including the audio signal and the voice signal. The element may include a selection of at least one of a channel, a volume, an EPG, a menu item, and an index added with an address of a web page. Thus, a person not having a visual impairment can more fully enjoy the content received by the electronic apparatus than that of the conventional apparatus in which the person not having a visual impairment cannot avoid listening the mixed sound signal together with the person having a visual impairment.

The method may further include: receiving a user's input; and outputting at least one of the audio signal and the mixed sound signal in accordance with the user's input. The step of receiving the user's input may include receiving one of a selection of a general mode and a selection of a voice guidance mode. Additional aspects of an exemplary embodiment may further include the steps of: outputting the audio signal if the general mode is selected; and outputting the mixed sound signal if the voice guidance mode is selected.

Therefore, even if the user identifier is not operating, a user, e.g., a person having a visual impairment, can engage the voice guidance mode through the user input portion and thus may receive guidance through the function of the electronic apparatus. Further, if the user identifier is unable to quickly determine whether the user desires the voice guidance mode or the general mode, the user can quickly change the electronic apparatus to the desired function.

The method may further include providing at least one of the audio signal and the mixed sound signal to a user. Thus, a user can selectively access the audio signal or the mixed sound signal as necessary.

The method may further include displaying an image corresponding to the content received by the electronic apparatus on a display. Thus, the electronic apparatus may be used with a digital TV, a smart TV, an Internet protocol (IP) TV, and the like.

In accordance with still another exemplary embodiment, there is provided a voice guidance method for a system including the foregoing electronic apparatus, and a display apparatus including a display configured to display an image corresponding to the content received by the electronic apparatus, the method including: acquiring user information of the users of the electronic apparatus; and selectively outputting at least one of an audio signal, corresponding to the content received by the electronic apparatus, and a mixed sound signal including the audio signal and a voice signal converted from text included in an element of a Graphical User Interface (GUI) of the electronic apparatus, in accordance with the acquired user information; and displaying the image corresponding to the content received by the electronic apparatus through the display. Thus, a set-top box, a DVD player, a BD player, or the like electronic apparatus capable of providing a content to the display apparatus may be connected to the display apparatus and offers the content to a user including a person having a visual impairment.

According to aspects of an exemplary embodiment, a method of providing an enhanced user interface to a person having a visual impairment utilizing an electronic apparatus comprising a content receiver configured to receive multimedia content, a display configured to display an image derived from the multimedia content, a text to speech engine configured to convert text included in an element of a Graphical User Interface (GUI) of the electronic apparatus into a voice signal, a user identifier configured to acquire user information of users of the electronic apparatus, an audio processor configured to generate an audio signal derived from the multimedia content and a mixed sound signal including the audio signal and the voice signal, and a controller configured to control selective output of at least one of the audio signal and the mixed sound signal in accordance with the user information acquired by the user identifier, includes: receiving multimedia content into the content receiver; receiving user information based on at least one user into the user identifier; selectively outputting at least one of the audio signal and the mixed sound signal based on the received user information.

The receiving user information may include receiving user profile information from the user by the user identifier, the user profile information comprising at least one of a photograph and a finger print; prompting the user to select from among a voice guidance mode and a silent mode; receiving the section of the user from among the voice guidance mode and the silent mode; outputting only the audio signal through a first output if the selection is the silent mode; outputting the mixed sound signal through a second output if the selection is the voice guidance mode; and storing the selection in association with the corresponding user profile information in a user profile in a storage device.

The receiving user information may include: in response to receiving the user profile information from the user, determining whether the user profile information corresponds to an existing user profile stored on the storage device, and if the user profile information corresponds to an existing user profile stored on the storage device, selectively outputting at least one of the audio signal and the mixed sound signal based on the selection stored in the user profile, and if the user profile information does not correspond to an existing user profile stored on the storage device, prompting the user to select from among the voice guidance mode and the silent mode.

### BRIEF DESCRIPTION OF THE DRAWINGS

These and other aspects of the exemplary embodiments will become apparent and more readily appreciated from the following description of the exemplary embodiments, taken in conjunction with the accompanying drawings, in which:

FIG. 1 illustrates a block diagram of an electronic apparatus having a voice guidance function according to an exemplary embodiment;

FIG. 2 illustrates a block diagram of a system including an electronic apparatus having a voice guidance function according to an exemplary embodiment;

FIG. 3 illustrates a block diagram of a system including an electronic apparatus having a voice guidance function according to an exemplary embodiment;

FIG. 4 illustrates a flowchart of a voice guidance process of an electronic apparatus according to an exemplary embodiment;

FIG. 5 illustrates a flowchart of a voice guidance process of an electronic apparatus according to an exemplary embodiment; and

FIG. 6 illustrates an example of text included in a function of a display apparatus that a text-to-speech (TTS) engine of an electronic apparatus having a voice guidance function may convert into speech according to an exemplary embodiment.

### DETAILED DESCRIPTION OF THE EXEMPLARY EMBODIMENTS

Below, exemplary embodiments of an electronic apparatus having a voice guidance function, a system including the same, and corresponding voice guidance methods will be described with reference to accompanying drawings.

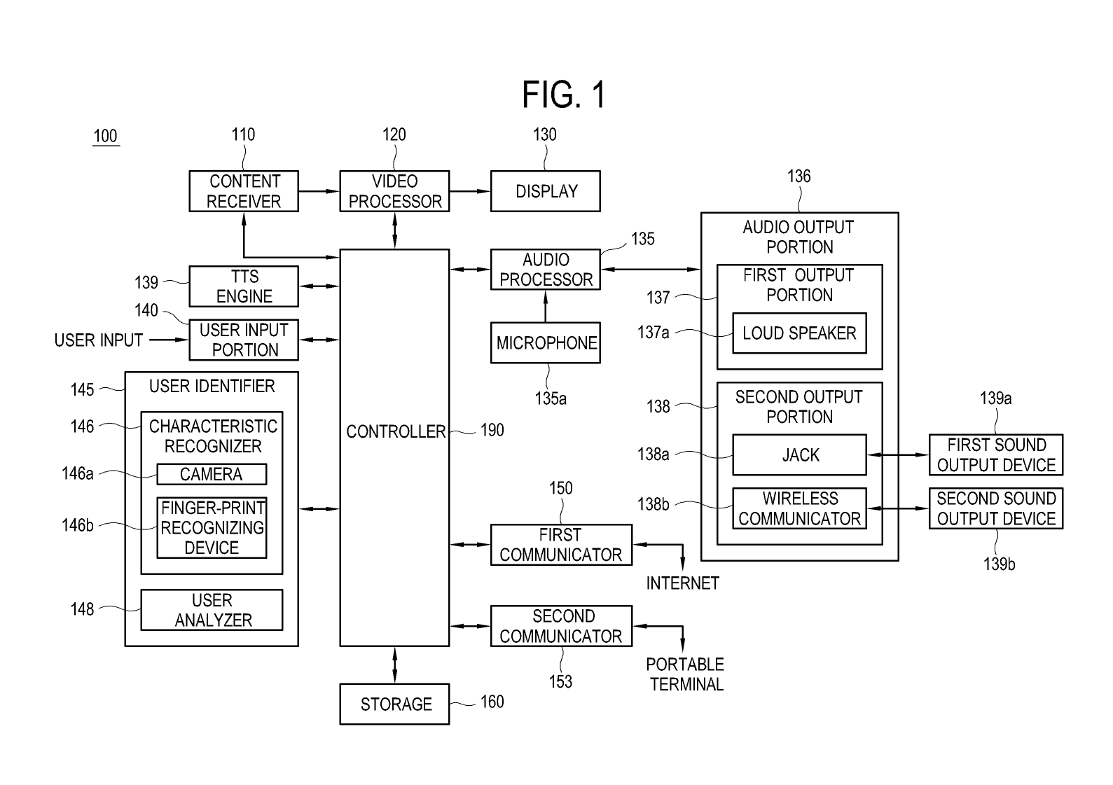

FIG. 1 illustrates a block diagram of an electronic apparatus having a voice guidance function according to an exemplary embodiment.

The electronic apparatus 100 has a voice guidance function that outputs a voice as a guide to an operating state of a display apparatus and/or to various display and selection states of a function of a display apparatus to assist a person having a visual impairment to easily use the function of the display apparatus. The electronic apparatus 100 may include a display apparatus including a digital television (TV), a smart TV, an Internet protocol (IP) TV, or a similar display apparatus capable of displaying an image; or a set-top box, a digital versatile disc (DVD) player, a Blu-ray disc (BD) player, or a similar electronic apparatus capable of transmitting content related to an image to a display apparatus.

Accordingly, although the electronic apparatus 100 is described below as being a display apparatus, the exemplary embodiments are not limited thereto.

Referring to FIG. 1, the electronic apparatus 100 includes a content receiver 110, a video processor 120, a display 130, an audio processor 135, a text to speech (TTS) engine 139, a user input portion 140, a user identifier 145, first and second communicators 150 and 153, a storage 160, and a controller 190.

The content receiver 110 may receive multimedia content such as a broadcast program, video on demand (VOD), and the like. For example, the content receiver 110 may receive a video signal included in a broadcast signal transmitted from a broadcast signal transmitter, a video signal from a DVD player, a BD player, or the like, a video signal from a personal computer (PC), a video signal through a network, or a video signal stored in a storage medium such as a universal serial bus (USB) storage.

The content receiver 110 may include a tuner or a connection interface.

The video processor 120 processes a video signal received in the content receiver 110 to be displayed as an image. The video processor 120 may perform processes such as decoding, image enhancing, scaling, etc.

The display 130 displays an image based on the video signal processed by the video processor 120. The display 130 is not limited to any particular method of displaying an image, and the display 130 may be a liquid crystal display (LCD), an organic light emitting diode (OLED), an active matrix organic light emitting diode (AMOLED), or a similar flat panel display.

Under control of the controller 190 and based on user information transmitted from a user analyzer 148 of the user identifier 145, the audio processor 135 may output an audio signal separated from the received broadcast signal by a demultiplexer, and/or a mixed sound signal including the audio signal and a voice signal generated by the TTS engine 139, to the audio output portion 136.

Further, a microphone 135a may be used as an element of the user identifier 145 for identifying whether a user is a person having a visual impairment. In this case, the audio processor 135 converts the sound signal input through the microphone 135a into voice data under control of the controller 190.

The controller 190 stores the converted voice data of the person having a visual impairment as reference information for identifying the person having a visual impairment in the storage 160, in accordance with a user's input. For example, the user may select a reference information setting item for a person not having a visual impairment or a person having a visual impairment through an external portable terminal that is able to interface with the user input portion 140 of the electronic apparatus 100 in a voice guidance setting menu of a firmware or operating program of the controller 190 (to be described later) displayed on the display 130.

The audio output portion 136 outputs a sound to a user based on an audio signal received from the audio processor 135, or provides a connection point through which the audio signal and the mixed sound signal are output. To this end, the audio output portion 136 includes a first output portion 137 for outputting a sound to a user based on an audio signal, and a second output portion 138 for providing the connection points through which an audio signal and a mixed sound signal are independently output.

The first output portion 137 may include a loud speaker 137a.

The second output portion 138 may include a jack 138a, and a wireless communicator 138b. The jack 138a may include a jack for an audio signal and a jack for a mixed sound signal to connect with the wired connection terminals of the external first sound output devices 139a, so that the audio signal and the mixed sound signal can be respectively output as sounds to corresponding users. Each of the first sound output devices 139a may include an earphone or a headphone.

The wireless communicator 138b includes a transmitter for an audio signal and a transmitter for a mixed sound signal, and wirelessly transmits the audio signal and the mixed sound signal to corresponding wireless receivers of the external second sound output devices 139b. The transmitter for the audio signal and the transmitter for the mixed sound signal may transmit signals in different modes to prevent crosstalk. For example, the transmitter for the audio signal and the transmitter for the mixed sound signal may transmit signals in an infrared mode and a radio frequency (RF) mode, an infrared mode and a BLUETOOTH® mode, or an RF mode and a BLUETOOTH® mode, respectively. Each of the second sound output devices 139b may include a wireless earphone, a wireless headphone or a hearing aid. The wireless earphone, the wireless headphone and the hearing aid may have an infrared mode, an RF mode and/or a BLUETOOTH® mode corresponding to the transmission modes of the transmitter for the audio signal and the transmitter for the mixed sound signal.

Using the audio output portion 136, a user may selectively access the sound of the multimedia content by itself or a mixed sound signal including the sound of the voice guidance function, as necessary.

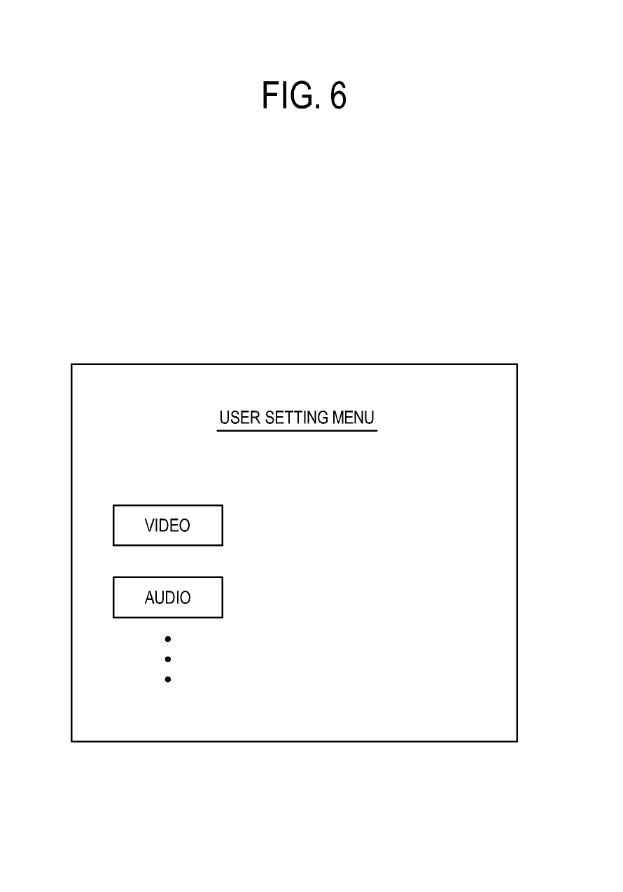

The TTS engine 139 converts content received through the content receiver 110 and text included in a function of the electronic apparatus 100 into a voice signal under control of the controller 190. For example, with reference to FIG. 6, if a user selects “Video” in a user setting menu of the operating program of the controller 190, the TTS engine 139 converts the selection into a voice signal, for example, a voice signal reciting “Video was selected in the user setting menu.”

The function of the electronic apparatus 100 may include functions based on a graphic user interface (GUI) or text, such as a channel change function, a volume control function, an electronic program guide (EPG) display function, a selection function for an index added with an address of a web page, etc., in addition to the function of selecting a menu item. A function may be displayed together with a word, a letter, a numeral, a character, and combinations thereof before and/or after performing the function. Thus, if a user is a person having a visual impairment, the electronic apparatus 100 may provide a voice for guiding the user through various functions using the GUI or text.

The TTS engine 139 may include a TTS program programmed to execute a TTS algorithm or a TTS application specific integrated circuit (ASIC) portion designed to run the TTS program. Below, the TTS ASIC portion designed to run the TTS program will be described as an example of the TTS engine 139.

The user input portion 140 receives a user's input regarding control of the electronic apparatus 100. A user's input includes a first input and a second input. The first input may include a selection of the voice guidance mode wherein voice guidance is performed or a selection of the general mode in which voice guidance is not performed. The second input may include a selection of a channel, a volume, an EPG, an index added with an address of a web page, a menu item, etc.

Although the elements of the user identifier 145 for determining whether a user has a visual impairment and sending a determination result to the controller 190 do not operate continuously, the user input portion 140 can directly receive a user's input about the voice guidance mode, so that voice guidance to the function of the electronic apparatus 100 can be provided to the user. Further, if the electronic apparatus 100 is unable to quickly perform a function corresponding to the voice guidance mode or the general mode desired by a user, the user can quickly change the function of the electronic apparatus to the desired function.

The user input portion 140 may include a remote controller provided with a plurality of input key buttons such as a voice-guidance mode button, a general mode button, etc., and a remote-signal receiver for receiving a remote signal having key-input information corresponding to a user's input from the remote controller. Alternatively, the user input portion 140 may further include a touch screen installed in the display 130.

The user identifier 145 is configured to acquire user information about whether a user is a person having a visual impairment, and includes a characteristic recognizer 146 for recognizing a user's unique characteristic information, and a user analyzer 148 for analyzing whether a user is a person having a visual impairment based on the user's unique characteristic information recognized by the characteristic recognizer 146 and generating a user information signal showing an analysis result. Thus, the electronic apparatus 100 can automatically acquire the user information about whether a user is person having a visual impairment.

The characteristic recognizer 146 recognizes a user's face, iris, voice print and/or finger print as the user's unique characteristic information. The characteristic recognizer 146 may include a camera 146a for photographing a user's face or iris, a microphone 135a for receiving an input of a user's voice, and/or a finger-print recognizing device 146b for receiving an input of a user's finger print. Such elements 146a, 135a and 146b of the characteristic recognizer 146 may be selectively provided in accordance with design or conditions of the electronic apparatus 100. Below, the camera 146a will be described as an example of the characteristic recognizer 146.

The camera 146a is configured to change an optical signal into a video signal, and may include a camera module. The camera module processes a video signal acquired by an image sensor to be converted into video data containing an image frame such as a still image, a moving image or the like. The converted video data may be displayed on the display 130 under control of the controller 190.

Further, the camera module may photograph a face of a user under control of the controller 190, in response to a user's input through the voice guidance setting menu in the firmware or operating program of the controller 190. In this case, the controller 190 previously stores an image frame of the user's photographed face in the storage 160 as reference information for identifying the user.

The user analyzer 148 determines whether a user is a person having a visual impairment based on a comparison between user's unique characteristic information recognized by the characteristic recognizer 146 while the electronic apparatus 100 is used and the unique characteristic information of a person having a visual impairment previously stored as the reference information for identifying the person having a visual impairment in the storage 160. The unique characteristic information previously stored in the storage 160 may further include the unique characteristic information of a person not having a visual impairment in addition to unique characteristic information of the person having a visual impairment. In this case, the unique characteristic information may be sorted into persons having a visual impairment information and persons not having a visual impairment information, and then stored together with the user's names.

The user analyzer 148 may include a recognition program or ASIC portion programmed to include a predetermined face recognition algorithm, an iris recognition algorithm, a voice print algorithm or a finger print algorithm in accordance with types of the characteristic recognizer 146. Below, the user analyzer 148, which includes the recognition ASIC portion programmed to include a face recognition algorithm, will be described by way of example.

Under control of the controller 190, the user analyzer 148 analyzes and extracts image frames of users' faces as user's face information from a user's surrounding image photographed using the camera 146a of the characteristic recognizer 146, and compares the extracted image frames of the users' faces with the image frames of the faces of persons having a visual impairment previously stored as the reference information in the storage 160. The user analyzer 148 determines that a user viewing the electronic apparatus 100 has a visual impairment or that one among the current users has a visual impairment if the comparison result shows that there is a matched user, and determines that a user does not have a visual impairment or that the current users include no person having a visual impairment if there is no matched user, thereby generating and transmitting a corresponding user information signal to the controller 190. The controller 190 controls the audio processor 135 to selectively output an audio signal of the content received through the content receiver 110 and/or a mixed sound signal where the audio signal and a voice signal converted by the TTS engine 139 are mixed, in response to the user information signal from the user analyzer 148.

Thus, a user can selectively access the audio signal or the mixed sound signal through the audio output portion 136. For example, if a user is a person not having a visual impairment, the user can access the audio signal by itself. On the other hand, if a user is a person having a visual impairment, the user can access the mixed sound signal. As a result, the electronic apparatus according to an exemplary embodiment allows a person not having a visual impairment to more fully enjoy the multimedia content than that of the conventional apparatus in which the person not having a visual impairment cannot avoid listening to the mixed sound signal together with the person having a visual impairment.

The first communicator 150 performs communication with an external service providing server and/or website through the Internet. The first communicator 150 exchanges information about a user's input and an analysis result of the input with the service providing server under control of the controller 190.

The second communicator 153 performs wired or wireless communication with an external portable terminal or the like. The second communicator 153 may include at least one module for short-range wireless communication, e.g., WI-FI®, BLUETOOTH®, IRDA®, ZIGBEE®, wireless local area network (WLAN) and ultra-wideband (UWB).

The storage 160 stores content displayed on the display 130 of the electronic apparatus 100 (e.g., a broadcast program, VOD, etc.) and/or various applications for operations or the like of the electronic apparatus 100.

Further, under control of the controller 190, the storage 160 stores the reference information to be used by the user analyzer 148 in determining whether there is a person having a visual impairment among users who are currently watching and listening to the electronic apparatus 100. The reference information may include a face image frame or iris data of a person having a visual impairment photographed by the camera 146a, finger-print data of the person having a visual impairment input through the finger-print recognizing device 146b, or voice data of the person having a visual impairment input through the microphone 135a, in accordance with a user's input through an external portable terminal allowed to interface with the remote controller of the user input portion 140 or the electronic apparatus 100 in the voice guidance setting menu of the firmware or operating program of the controller 190. Below, the image frame of a face of a person having a visual impairment photographed by the camera 146a will be described as an example of the reference information.

The storage 160 may include at least one type of a storage medium among a flash memory type, a hard disk type, a multimedia card micro type, a card type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The controller 190 controls the general functions of the electronic apparatus 100, including the functions of the electronic apparatus 100 in accordance with an input signal received from an external portable terminal or the like through the user input portion 140 and the second communicator 153.

Further, as mentioned above, the controller 190 controls the audio processor 135 to selectively output the audio signal of the content and/or the mixed sound signal in accordance with a user's first input received through the user input portion 140 and/or user information acquired by the user identifier 145.

In more detail, when a user selects an item for setting the reference information about the determination of whether the user has a visual impairment through the voice guidance setting menu of the firmware or operating program, the controller 190 controls the camera module of the camera 146a to photograph the face of a user having a visual impairment, and stores the image frame of the photographed face together with a user's name as the reference information in the storage 160.

Then, the controller 190 drives the camera module of the camera 146a to photograph a surrounding image of a user at certain intervals of time, i.e., every 10 minutes, when the user watches the electronic apparatus 100, and controls the user analyzer 148 to acquire the user information.

If user information revealing that there is no person having a visual impairment among the current users is received from the user identifier 145, the controller 190 controls the audio processor 135 to output only an audio signal of the content received through the content receiver 110 to the first output portion 137 of the audio output portion 136.

In addition, if user information revealing that there is a person having a visual impairment among the current users is received from the user identifier 145, the controller 190 controls the TTS engine 139 to analyze the received content and functions of the electronic apparatus 100 corresponding to a user's first input received through the user input portion 140 and a second input different from the first input so that texts involved in the content and function can be converted into a sound signal (see FIG. 6), and controls the audio processor 135 to output the mixed sound signal, in which the audio signal and the converted sound signal are mixed, to the first output portion 138.

The controller 190 outputs the audio signal and the mixed sound signal through the second output portion 138, and at the same time outputs the audio signal through the first output portion 137. The audio signal output to the second output portion 138 is output as a sound to a person not having a visual impairment through the first or second sound output device 139a or 139b connected to the jack 138a or the wireless communicator 138b by a wire or wirelessly. In addition, the mixed sound signal output to the second output portion 138 is output as a sound to a person having a visual impairment through the first or second sound output device 139a or 139b connected to the jack 138a or the wireless communicator 138b by a wire or wirelessly.

If a general mode button of the remote controller of the user input portion 140 is pressed or if a user's first input of selecting the general mode is input in the voice guidance setting menu of the firmware or operating program of the controller 190 though the remote controller or the like of the user input portion 140, the controller 190 controls the audio processor 135 to output only an audio signal of the content to the first output portion 137, just as when the user information informing that there is no person having a visual impairment among the current users is received from the user identifier 145.

Further, if a voice-guidance mode button of the remote controller of the user input portion 140 is pressed or if a user's first input of selecting the voice-guidance mode is input though the remote controller or the like of the user input portion 140, the controller 190 controls the audio processor 135 to output a mixed sound signal through the second output portion 138 while controlling the TTS engine 139 so that text involved in the content and the functions of the electronic apparatus 100 can be converted into a voice signal, just as when the user information informing that there is a person having a visual impairment among the current users is received from the user identifier 145.

The controller 190 includes a central processing unit (CPU), and operates by executing a firmware or operating program programmed with contents for controlling operations of elements having the voice guidance function according to an exemplary embodiment. The controller 190 may further include a nonvolatile memory such as a flash memory or the like for storing the operating program, and a volatile memory such as a DDR for loading at least a portion of the operating program stored to be quickly accessed by the CPU.

Alternatively, the firmware or the operating program may not store the voice guidance function, and may be programmed with only a content for controlling the operations of each element. In this case, the voice guidance function may be programmed in a separate voice guidance program and stored in the storage 160. In this case, the voice guidance program stored in the storage 160 may be executed by the controller 190 when a user makes a request for executing the program through the remote controller or the like of the user input portion 140.

As described above, the electronic apparatus 100 according to an exemplary embodiment may provide the voice guidance function to a person having a visual impairment, but the exemplary embodiments are not limited thereto. For example, in the case of a person having a mild hearing-impairment, the electronic apparatus 100 may offer a sound increased in volume or having a reinforced high-frequency component to the person having a mild hearing-impairment through the jack 138a of the second output portion 138 and a separate output path of the wireless transmitter 138 on the same principle as the voice guidance function for a person having a visual impairment. In this case, the storage 160 stores unique characteristic information of a person having a mild hearing-impairment. The user identifier 145 acquires user information by comparison between recognized unique characteristic information of a user and the stored unique characteristic information of the person having a mild hearing-impairment and sends the user information to the controller 190.

The controller 190 controls the audio processor 135 to output a sound, which is increased in volume or having a reinforced high-frequency component in accordance with the user information received from the user identifier 145, through the jack 138a of the second output portion 138 and the separate output path of the wireless communicator 138b. In result, a person having a mild hearing-impairment can listen to the reinforced sound through the first sound output device 139a connected to the jack 138a or the second sound output device 139b connected to the output path of the wireless communicator 138b.

Also, as described above, the electronic apparatus 100 according to an exemplary embodiment includes the display apparatus, but the exemplary embodiments are not limited thereto. For example, the electronic apparatus 100 according to an exemplary embodiment may include a set-top box, a DVD player, a BD player or the like electronic apparatus that connects with a display apparatus 200, 200′ and provides content including an image without the display 130.

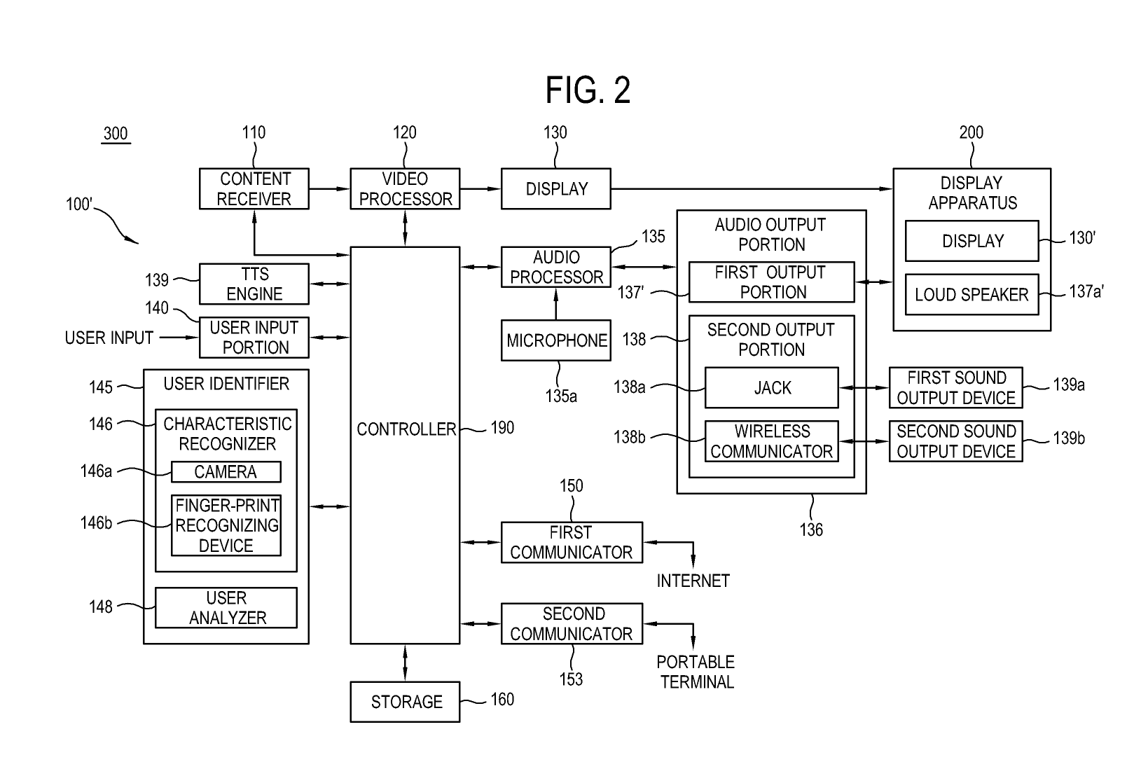

For example, as shown in FIG. 2, the set-top box, the DVD player, the BD player and the like electronic apparatus 100′ may connect with the display apparatus 200, thereby constituting a voice guidance system 300. The display 130′ is provided in the display apparatus 200, rather than the electronic apparatus 100′, and a loud speaker 137a′ is also provided in the display apparatus 200, rather than the electronic apparatus 100′, and is connected to a connector of a first output portion 137′ of the audio output portion 136.

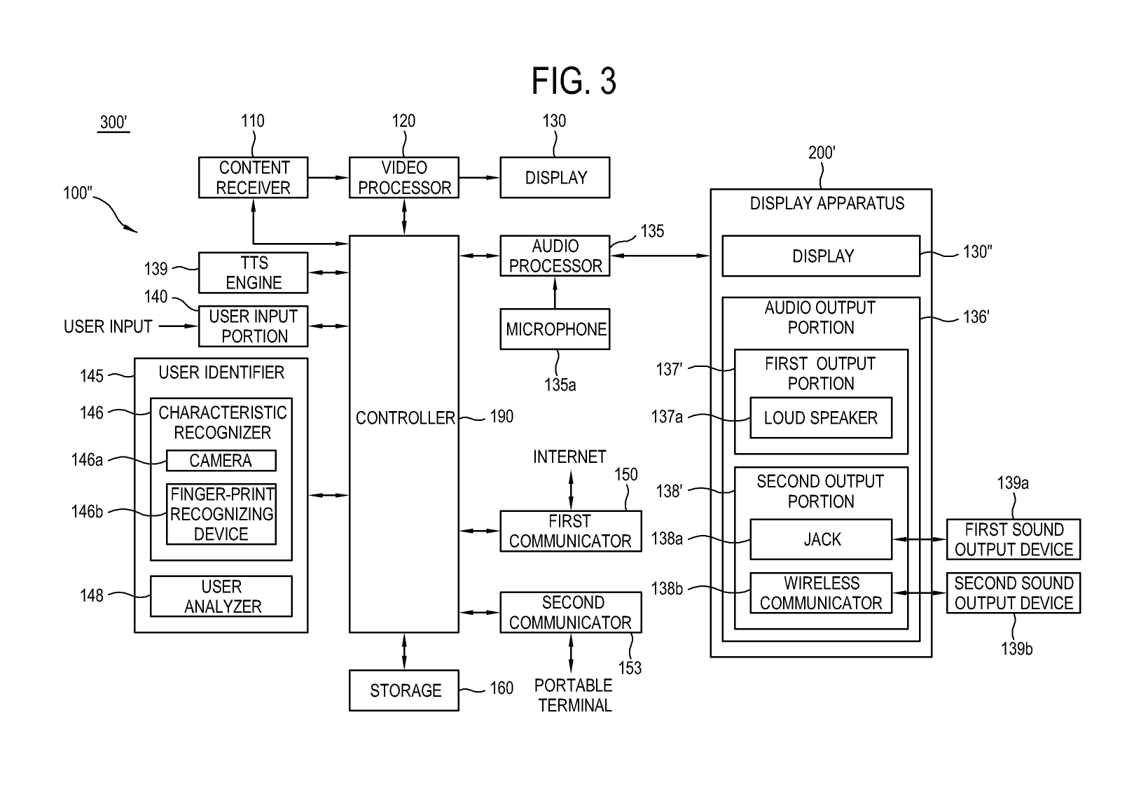

Further, as shown in FIG. 3, the electronic apparatus 100″ may connect with the display apparatus 200′, thereby constituting a voice guidance system 300′. The display 130″ is provided in the display apparatus 200′, rather than the electronic apparatus 100″. An audio output portion 136′ may also include the first and second output portions 137′ and 138′ provided in the display apparatus 200′, rather than the electronic apparatus 100″.

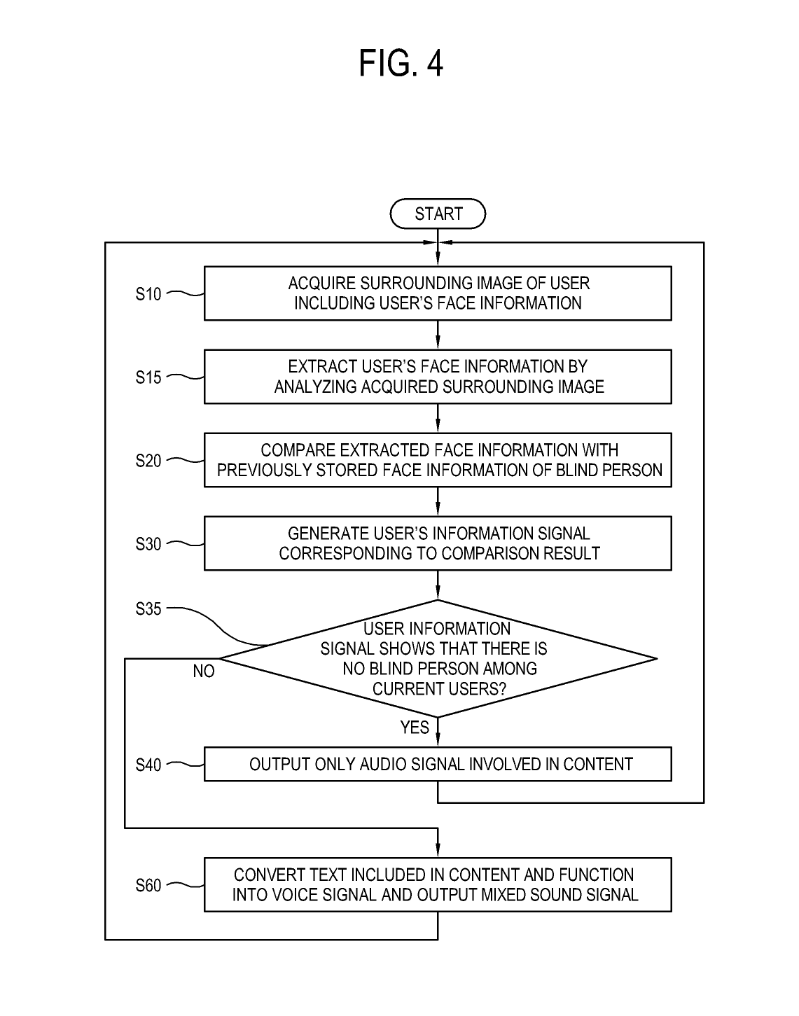

With this configuration, the voice guidance process of the electronic apparatus 100 according to an exemplary embodiment will be described with reference to FIG. 4.

FIG. 4 illustrates a flowchart of the voice guidance process of the electronic apparatus 100 according to an exemplary embodiment.

First, when a user turns on the electronic apparatus 100 and watches and listens to content reproduced by the electronic apparatus 100, the user identifier 145 acquires the user information.

That is, the controller 190 drives the camera 146a of the characteristic recognizer 146 to photograph a surrounding image of a user, which includes the user's unique characteristic information, such as face information (e.g., a face image frame), once per a first time period, e.g., once every 10 minutes, while the user watches and listens to the electronic apparatus 100 (S10). Here, the unique characteristic information may include the iris information, voice print information, or finger print information of the user instead of the face information.

Then, the controller 190 extracts a user's face information by analyzing the user's surrounding image acquired by a predetermined face recognition algorithm (S15), compares the extracted face information with the face information (i.e., the face image frame) of the person having a visual impairment previously stored in the storage 160 as the reference information (S20), and controls the user analyzer 148 to generate a user information signal informing that a person having a visual impairment exists among current users if the comparison result shows matched face information and informing that a person having a visual impairment does not exist among the current users if there is no matched face information (S30).

Then, the controller 190 controls the audio processor 135 to output only the audio signal of the content received through the content receiver 110 in accordance with identification information generated by the user identifier 145, or controls the TTS engine 139 to convert the text included in the content and the function of the electronic apparatus 100 into a voice signal by analyzing the function of the electronic apparatus 100 corresponding to a user's first input received through the user input portion 140 and a second input different from the first input and at the same time controls the audio processor 135 to output the mixed sound signal including the audio signal and the voice signal.

That is, the controller 190 determines whether the user information generated by the user identifier 145 shows that there is no person having a visual impairment among current users (S35).

If it is determined in the operation S35 that no person having a visual impairment exists among the current users, the controller 190 controls the audio processor 135 to output only the audio signal included in the content received through the content receiver 110 to the audio output portion 136 (S40). The audio signal output by the audio processor 135 is sent to a user through the first output portion 137 of the audio output portion 136.

If it is determined in the operation S35 that there is a person having a visual impairment among the current users, the controller 190 controls the TTS engine 139 to convert the text contained in the content and function of the electronic apparatus 100 into the voice signal and at the same time controls the audio processor 135 to output the mixed sound signal as described above (S60). The controller 190 controls the audio processor 135 to output the mixed sound signal where the audio signal and the voice signal are mixed, and output the audio signal to the audio output portion 136. As described above, the audio signal and the mixed sound signal output by the audio processor 135 are transmitted to a user through the first output portion 137 and/or the second output portion 138 of the audio output portion 136.

After the operation S40 or S60, the controller 190 repeats the operations following the operation S10 until the electronic apparatus 100 is turned off.

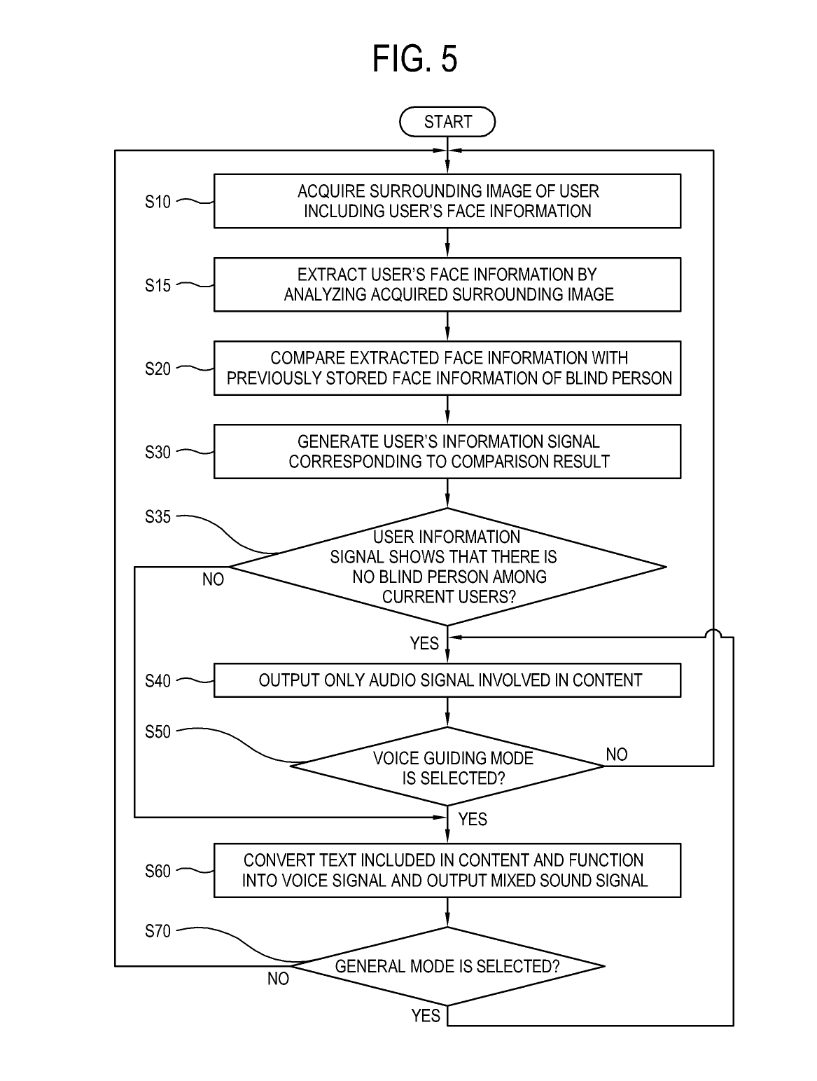

FIG. 5 illustrates a flowchart of a voice guidance process of an electronic apparatus 100 according to aspects of an exemplary embodiment.

As compared with the foregoing voice guidance process in FIG. 4, the voice guidance process of the electronic apparatus 100 in FIG. 5 additionally includes an operation of selecting the general mode and an operation of selecting the voice-guidance mode, and thus all the operations except operations S50 through S70 are the same as above. Thus, only the operations following the operation S40 will be described.

While the audio signal is output in the operation S40, the controller 190 determines whether the voice-guidance mode button on the remote controller of the user input portion 140 is pressed, or whether the voice-guidance mode item is selected as a user's first input through the remote controller or the like of the user input portion 140 in the voice guidance setting menu of the firmware or operating program, once per a second time period, e.g., once every one hour (S50).

If it is determined in the operation S50 that the voice-guidance mode item is not selected, the controller 190 repeats the operations following the operation S10.

If it is determined in the operation S50 that the voice-guidance mode item is selected, the controller 190 controls the TTS engine 139 to convert text included in a content and function of the electronic apparatus 100 into a voice signal as described above, and at the same time controls the audio processor 135 to output the mixed sound signal to the audio output portion 136 (S60). The operation S60 takes priority over the operation S40. At this time, the controller 190 controls the audio processor 135 to output the audio signal to the audio output portion 136. As described above, the audio signal and the mixed sound signal output by the audio processor 135 to the audio output portion 136 are given to a user through the first output portion 137 and/or the second output portion 138.

If it is determined in the operation S35 that a person having a visual impairment exists among current users, the controller 190 performs the foregoing operation S60.

While performing the operation S60, the controller 190 determines whether the general mode button on the remote controller of the user input portion 140 is pressed, or whether the general mode item is selected as a user's first input through the remote controller or the like of the user input portion 140 in the voice guidance setting menu of the firmware or operating program, once per a second time period, e.g., once every one hour (S70).

If it is determined in the operation S70 that the general mode item is selected, the controller 190 performs the operation S40.

If it is determined in the operation S70 that the general mode item is not selected, the controller 190 repeats the operations following the operation S10.

As described above, there are provided the electronic apparatuses 100, 100′, 100″ having the voice guidance function according to an exemplary embodiment, the system 300, 300′ having the same, and the voice guidance methods thereof, in which an audio signal of a content and a mixed sound signal where the audio signal of the content and a voice signal converted by the TTS engine 139 are mixed are respectively output through different paths, and therefore a user can selectively access the audio signal or the mixed sound signal as necessary. For example, if a user is a person not having a visual impairment, the user has access to the audio signal. Further, if a user is a person having a visual impairment, the user has access to the mixed sound signal. As a result, a person not having a visual impairment can more fully enjoy the content than that of the conventional electronic apparatus in which the person not having a visual impairment cannot avoid listening to the mixed sound signal together with the person having a visual impairment.

Further, there are provided the electronic apparatuses 100, 100′, 100″ having the voice guidance function according to an exemplary embodiment, the system 300, 300′ having the same, and the voice guidance methods thereof, in which the user identifier 145 includes the characteristic recognizer 146 for recognizing a user's unique characteristic information, and the user analyzer 148 for generating a user information signal showing whether the user is a person having a visual impairment based on the user's unique characteristic information recognized by the characteristic recognizer 146. Therefore, the electronic apparatus 100 can automatically acquire the user information about whether a user is a person having a visual impairment.

Although a few exemplary embodiments have been shown and described, it will be appreciated by those skilled in the art that changes may be made in these exemplary embodiments without departing from the principles and spirit of the invention. Therefore, the foregoing has to be considered as illustrative only. The scope of the invention is defined in the appended claims and their equivalents. Accordingly, all suitable modification and equivalents may fall within the scope of the invention.

What is claimed is:

1. An electronic apparatus having a voice guidance function, the electronic apparatus comprising:
a text to speech (TTS) engine configured to convert text included in an element of a Graphical User Interface (GUI) of the electronic apparatus into a voice signal;
a user identifier configured to acquire user information of users of the electronic apparatus;
an audio processor configured to output an audio signal corresponding to content reproduced by the electronic apparatus and a mixed sound signal comprising the audio signal and the voice signal; and
a controller configured to control the audio processor to selectively output at least one of the audio signal and the mixed sound signal in accordance with the user information acquired by the user identifier.

2. The electronic apparatus according to claim 1, wherein the element comprises a graphic user interface (GUI) text.

3. The electronic apparatus according to claim 2, wherein the element comprises one of a channel change function, a volume control function, a selection function for an electronic program guide (EPG), a selection function of a menu item, and a selection function for an index added with an address of a web page.

4. The electronic apparatus according to claim 1, wherein the user identifier comprises:
a characteristic recognizer configured to receive information from a user; and
a user analyzer configured to determine whether the user has a visual impairment based on the information received by the characteristic recognizer and to generate a user information signal corresponding to a result of the determining.

5. The electronic apparatus according to claim 4, wherein the information received from the user comprises one of face information, iris information, voice print information, and finger print information.

6. The electronic apparatus according to claim 1, further comprising a user input portion configured to receive a first input and second input from a user,
wherein the controller is further configured to selectively perform at least one of controlling the audio processor to output only the audio signal, and controlling the audio processor to output only the mixed sound signal, in accordance with at least one of the first input received through the user input portion and the user information acquired by the user identifier.

7. The electronic apparatus according to claim 6, wherein the first input comprises a selection from among a voice guidance mode and a general mode, and
the second input comprises a selection from among at least one of a channel, a volume, an EPG, a menu item, and an index added with an address of a web page, wherein the general mode is a mode without voice guidance.

8. The electronic apparatus according to claim 1, further comprising an audio output portion configured to receive the audio signal and the mixed sound signal from the audio processor, to output a sound corresponding to the audio signal, and to provide a hub for selectively transmitting the audio signal and the mixed sound signal.

9. The electronic apparatus according to claim 8, wherein the audio output portion comprises:
a first output portion configured to output the sound corresponding to the audio signal; and
a second output portion configured to provide the hub for selectively transmitting the audio signal and the mixed sound signal.

10. The electronic apparatus according to claim 9, wherein
the first output portion comprises a speaker, and
the second output portion comprises a jack configured to connect with a connection terminal of a first sound output device, and a wireless transmitter configured to wirelessly communicate with a wireless receiver of a second sound output device.

11. The electronic apparatus according to claim 10, wherein the first sound output device comprises one of an earphone and a headphone, and the second sound output device comprises one of a wireless earphone, a wireless headphone, and a hearing aid.

12. The electronic apparatus according to claim 1, further comprising a display configured to display an image corresponding to the content reproduced by the electronic apparatus.

13. A voice guidance system, the system comprising:
an electronic apparatus having a voice guidance function; and
a display apparatus configured to display an image corresponding to content reproduced by the electronic apparatus,
wherein the electronic apparatus comprises:
a text to speech (TTS) engine configured to convert text included in an element of a Graphical User Interface (GUI) of the electronic apparatus into a voice signal;
a user identifier configured to acquire user information of users of the electronic apparatus;
an audio processor configured to output an audio signal corresponding to the content reproduced by the electronic apparatus and a mixed sound signal comprising the audio signal and the voice signal; and
a controller configured to control the audio processor to selectively output at least one of the audio signal and the mixed sound signal in accordance with the user information acquired by the user identifier.

14. A voice guidance method for an electronic apparatus, the method comprising:
acquiring user information of users of the electronic apparatus; and
selectively outputting at least one of an audio signal, corresponding to content reproduced by the electronic apparatus, and a mixed sound signal, comprising the audio signal and a voice signal converted from text included in an element of a Graphical User Interface (GUI) of the electronic apparatus, in accordance with the acquired user information.

15. The method according to claim 14, wherein the acquiring comprises:
receiving information from a user of the electronic apparatus; and
acquiring the user information based on the information received from the user.

16. The method according to claim 15, wherein the user information comprises information indicating whether the user has a visual impairment, and
the information received from the user comprises one of face information, iris information, voice print information, and finger print information.

17. The method according to claim 14, further comprising the steps of:
determining whether a user having a visual impairment is present based on the user information;
if the user having a visual impairment is not present, outputting only the audio signal; and
if the user having a visual impairment is present, outputting the mixed sound signal comprising the audio signal and the voice signal.

18. The method according to claim 17, wherein the element comprises a selection of at least one of a channel, a volume, an EPG, a menu item, and an index added with an address of a web page.

19. The method according to claim 14, further comprising:
receiving a user's input; and
outputting at least one of the audio signal and the mixed sound signal in accordance with the user's input.

20. The method according to claim 19, wherein the step of receiving the user's input comprises receiving one of a selection of a general mode and a selection of a voice guidance mode, wherein the general mode is defined as a mode without voice guidance.

21. The method according to claim 20, further comprising the steps of:
outputting the audio signal if the general mode is selected; and
outputting the mixed sound signal if the voice guidance mode is selected.

22. The method according to claim 14, further comprising providing at least one of the audio signal and the mixed sound signal to a user.

23. The method according to claim 14, further comprising displaying an image corresponding to the content received by the electronic apparatus on a display.

24. A voice guidance method for a system comprising an electronic apparatus configured to receive content, and a display apparatus comprising a display configured to display an image corresponding to the content received by the electronic apparatus, the method comprising:
acquiring user information of users of the electronic apparatus;
selectively outputting at least one of an audio signal, corresponding to the content received by the electronic apparatus, and a mixed sound signal, comprising the audio signal and a voice signal converted from text included in an element of a Graphical User Interface (GUI) of the electronic apparatus, in accordance with the acquired user information; and
displaying the image corresponding to the content received by the electronic apparatus through the display.
